(19) United States
(12) Patent Application Publication
(10) Pub. No.: US 2025/0181338 A1
(43) Pub. Date: Jun. 5, 2025

(54) SYSTEM OR METHOD CAPABLE OF INSTALLING OR RUNNING A SERVER APP

(71) Applicant: Geum-Cheol KIM, Gyeonggi-do (KR)

(72) Inventor: Geum-Cheol KIM, Gyeonggi-do (KR)

(21) Appl. No.: 17/776,766

(22) PCT Filed: Nov. 11, 2020
(86) PCT No.: PCT/KR2020/015736

§ 371 Date: May 13, 2022

(30) Foreign Application Priority Data
Nov. 12, 2019 (KR) 10-2019-0144584

(51) Int. Cl. G06F 8/61; G06F 21/31

(52) U.S. Cl. CPC G06F 8/61; G06F 21/31

(57) ABSTRACT

A PS, which can determine PS login by using a personal URL, a URL password, or other information, installs an S-app of a server app in itself or a T-app of server app in an external device of the PS(=personal server).

A PS, which can determine PS login by using a personal URL, a URL PWD, or other information, runs an S-app or the S-app runs a T-app.

In a face-to-face state, the PS capable of determining a PS login by using certain elements or information received from the device of other person runs an S-app or the S-app runs a T-app. Here, the information received from the device of other person can include registration-other person information, PS log information, R-terminal information, or other information.

In a non-face-to-face state, a PS capable of determining a PS login by using certain elements information received from the device of other person, or other elements runs an S-app or the S-app runs a T-app. Here, the information received from the device of other person can include RS information, PS log information, or other information.

### TECHNICAL FIELD

It installs or runs an app and uses service.

### DISCUSSION OF RELATED ART

(An app) a) (Definition or overview) An app is the application software for transactions. The application software integrated with system software is not an app because it cannot be traded on a per-application software basis. All apps are application software, but some of application software is not app. Since the app is for transaction, it may be installed or deleted at the user's will. Apps installed in advance on smart phones are application software for transactions because they are included in the transaction of smart phones and can be deleted by the user's will. b) (New classification criteria for apps) Apps can be classified into terminal apps and server apps depending on the device to be installed or started. This classification is new, and currently there are only terminal apps installed and started on the terminal.

(A terminal app) a) (Definition) A terminal app is the app that is installed in a terminal and started. An app can interlocked with a terminal or a server, after being started in the terminal. b) A terminal app can store protection information in a terminal. c) (Registration of terminal app identifier=icon) Terminal app identifier is registered in a terminal. d) A terminal app is software configured in one form and can include hardware control functions, public information, protection information, or other information. A terminal app is not composed of two or more software.

(Protection information) a) Protection information is the app information that needs protection. A terminal app can include protection information fundamentally or can receive and include the protection information from a user. An ID card terminal app fundamentally includes ID information, and a payment terminal app includes card information or account information received from a user. b) The protection information of a terminal app is stored in a terminal. Currently, the protection information of a terminal app is not stored in the external device of a terminal.

(Installation of a terminal app) a) A terminal, which has decided to log in with terminal login information (refer to ‘terminal Login Information’ below) installs the terminal app received from the terminal app market in a terminal (refer to [0002] of KR 10-2009182, of KR 10-1781129). b) The external device of the terminal cannot install the terminal app, and the terminal app cannot be installed in the external device of the terminal.

(Execution of a terminal app) a) When a user logs in to a terminal with terminal login information and clicks the terminal app (terminal app icon) among the terminal app list (terminal app icon list), the terminal app starts. The terminal app is started in the terminal and then can interlock with the terminal or the server.

(Problems of a terminal app) a) Terminal apps are likely to be hacked or contaminated. b) A terminal app can be leaked according to the loss or replacement of a terminal. c) Since the protection information of a terminal app is stored in a terminal, it is difficult to protect or the protection cost is high. d) A terminal app cannot support a method of preventing hacking, a method of detecting hacking, or others in conjunction with an external device (server, etc.). e) Since a terminal app stores protection information in a terminal, it is difficult to service information with a high security level. f) Since a terminal app is installed in a terminal, it is impossible to implement an app that back up a terminal. g) A terminal app cannot support the service that uses the terminal of other person. For example, a user cannot use a terminal app's service by using the terminal of a bank employee.

(A terminal app market) a) A terminal app market is the system (a server, etc.) that can support the transaction of a terminal app (refer to of KR 10-2009182 or of KR 10-1781129). b) ‘App Store’ or ‘Play Store’ is a kind of a terminal app market. ‘App Store’ or ‘Play Store’ does not support the transaction of the app to install in a server.

(A market terminal app) a) A market terminal app is the terminal app that supports a terminal app market. There is the app store terminal app, the play store terminal app, or other market terminal apps. b) A market terminal app is installed in a terminal and can support access to a terminal app market. A market terminal app cannot be installed in the external device of a terminal.

(A terminal) a) A terminal is the device that a terminal app is installed and is used directly by a user. The current terminal does not include the terminal of other person (e.g., a bank terminal, a government terminal, or other terminal). Currently, a user can only use his/her terminal in which a terminal app is installed. b) (Type) A terminal have a smart phone, a tablet PC, a PC, or other devices.

(Terminal login information) a) Terminal login information is one password (secret number, secret pattern, biometric information, or others) for logging in to a terminal (screen security release). Terminal login information does not include an ID.

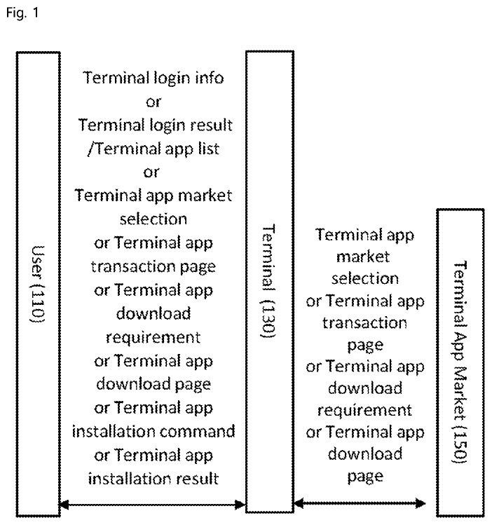

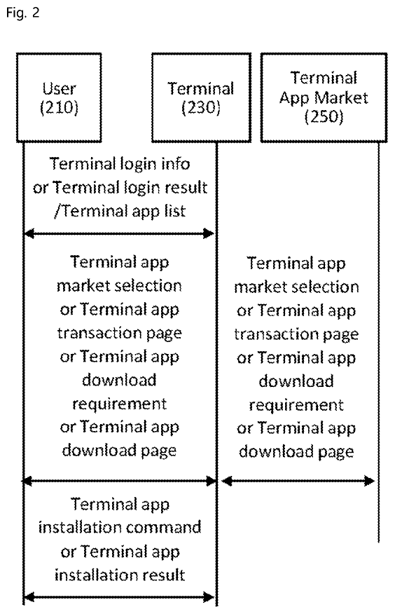

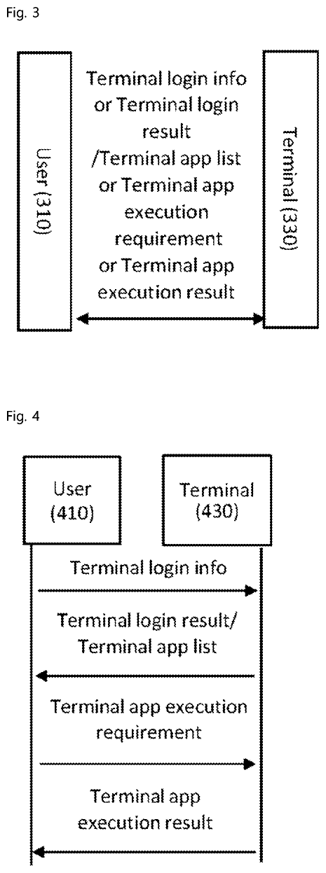

(A terminal login) a) A terminal login is what logging in to a terminal and releasing a screen security of the terminal.

<1. A terminal app installation system. Refer to FIG. 1. Refer to or a representative diagram (excluding the smart table portion) of KR 10-2009182.>A terminal app installation system that a terminal, which has decided to log in with terminal login information, can install the terminal app received from the terminal app market, comprising: a terminal that can store terminal login information, release screen security with terminal login information received from a user, deliver a terminal login result or a terminal app list to a user, deliver a terminal app market selection received from a user to a terminal app market, communicate a terminal app transaction page with a terminal app market and a user, deliver a user's a terminal app download requirement to a terminal app market, communicate a terminal app download page, which includes downloading a terminal app, with a terminal app market and a user, receive a terminal app installation command from a user, install a terminal app in response to a terminal app installation command, and deliver a terminal app installation result to a user; and a terminal app market that can include a terminal app or others, receive a terminal app market selection from a terminal, communicate a terminal app transaction page with a terminal, receive a terminal app download requirement from a terminal, and communicate a terminal app download page with a terminal;

<2. A terminal app installation method. See FIG. 2> A terminal app installation method that a terminal, which has decided to log in with terminal login information, can install the terminal app received from a terminal app market, comprising: step a) in which a terminal releases screen security with terminal login information received from a user, delivers a terminal login result or a terminal app list to a user, and delivers a user's a terminal app market selection to a terminal app market; step b) in which a terminal app market communicates a terminal app transaction page with a terminal; step c) in which a terminal delivers a terminal app transaction page to a user and delivers to a terminal app market a terminal app download requirement received from a user; step d) in which a terminal app market communicates with a terminal a terminal app download page, which include downloading a terminal app; step e) in which a terminal delivers a terminal app download page to the user, receives a terminal app installation command from a user, installs a terminal app in response to a terminal app installation command, and delivers a terminal app installation result to a user.

<3. A terminal app execution system and method. See FIGS. 3 and 4> A terminal app execution system and method that can store terminal login information, release a screen security by using the terminal login information received from a user, deliver a terminal login result or a terminal app list to the user, receive a terminal app execution requirement from the user, run a terminal app in response to the terminal app execution requirement, and deliver a terminal app execution result to the user.

(A user) a) A user is a subject who can use a terminal app.

(Terminal information) a) Terminal information is the information related to a terminal, and there are a terminal's IP, OS serial number, MAC address, device identification information (IMEI, International Mobile Equipment Identity), or others. b) The terminal information can be used to verify a terminal's ID or a terminal itself.

(A terminal login result/a terminal app list) a) A terminal login result/a terminal app list is a terminal login result or a terminal app list. b) A terminal login result is the result of checking terminal login information, and a terminal app list is the list of terminal apps. c) A user can click a market terminal app of a terminal app list and connect to a terminal app market, or request a terminal app's execution.

(A terminal app market selection) a) A terminal app market selection is what selecting a market terminal app and what requesting in order to access a terminal app market. b) A user can deliver a terminal app market selection in a method, how clicking a market terminal app icon of a terminal app list, or other method. c) A terminal can connect to a terminal app market in response to a terminal app market selection.

(A terminal app transaction page) a) A terminal app transaction page is the web page that can support the transaction of a terminal app. b) A terminal app transaction page can include a terminal app introduction window, a terminal app search window, a download requirement window, or other information.

(A terminal app download requirement) a) A terminal app download requirement is what requesting the download of a terminal app. b) A terminal app market can download a terminal app in response to a terminal app download requirement to a terminal.

(A terminal app download page) a) A terminal app download page is the page that supports the download of a terminal app, etc. b) A terminal app download page can include a download of a terminal app, a download progress bar, a download result, a terminal app installation command window, or other information.

(A terminal app installation command) a) A terminal app installation command is the command to install a terminal app. b) A terminal can install a terminal app in response to a terminal app installation command.

(A terminal app installation) a) A terminal can install a terminal app in itself in response to a terminal app installation.

(A terminal app installation result) a) A terminal app installation result is the result of installing a terminal app. b) A terminal app installation result can include a terminal app identifier, a message, or other information.

(A terminal app execution requirement) a) A terminal app execution requirement is what requesting a terminal app's execution. b) A terminal can run a terminal app in response to a terminal app execution requirement.

(A terminal app execution) a) A terminal app execution can include the operations that a terminal app uses protection information or a terminal's hardware, interworks with a terminal or a server, or does other function.

(A terminal app execution result) a) A terminal app execution result is the result of running a terminal app or responding to a terminal app execution requirement. b) A terminal app execution result can include information, a message, service, or other information.

a) (Installation or execution of a server app) It provides the means that a PS (a personal server) installs or runs a server app. At present, a terminal installs or runs a terminal app.

b) (A means running a server app safely) It provides the means checking a user more conveniently and safely and running a server app. It can connect to a PS conveniently with a personal URL medium's personal URL, log into a PS more safely with a personal URL, a URL password, terminal information, or other information, and run a server app. However, at present, it logs into a terminal with the one password capable of being leaked for being stored in the terminal and runs a terminal app.

c) (Protecting information safely) It safely protects a server app's protection information by storing it in a PS. However, at present, since terminal app's protection information is stored in a terminal, so there is the possibility of being hacked or leaked.

d) (A server app market) It provides the server app market capable of supporting the transaction of a server app. However, at present, a terminal app market supports the transaction of a terminal app.

e) (Preventing damage from contamination) It provides the means that a terminal's external device (an S-app of a PS or other information) can check whether the T-app of a terminal is contaminated and run a server app. However, at present, the external device of a terminal cannot check whether a terminal app is contaminated.

f) (Prevention of contamination) It provides the means that a terminal's external device (a PS's S-app, an app key, or other things) prevents contamination or hacking of the T-app of a terminal. However, at present, the means installed in a terminal prevents contamination or hacking of the terminal app of the terminal.

g) (In face-to-face state, using the server app of other person's device) In face-to-face state, it provides the means capable of using the server app of other person's device. However, at present, in face-to-face state, the terminal app of other person's device cannot be available.

h) (In non-face-to-face state, using the server app of other person's device) In non-face-to-face state, it provides the means capable of using the server app of other person's device. However, at present, in non-face-to-face, the terminal app of other person's device cannot be available.

i) (Providing various server apps) It provides more diverse and more advanced server apps. For example, it provides the server app (the virtual terminal server app) capable of backing up a terminal.

j) (Creation of added values) It provides the means capable of creating added values by using the process running a server app.

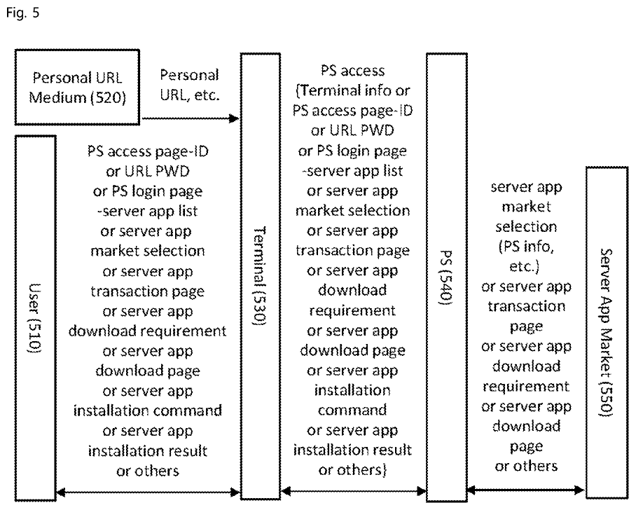

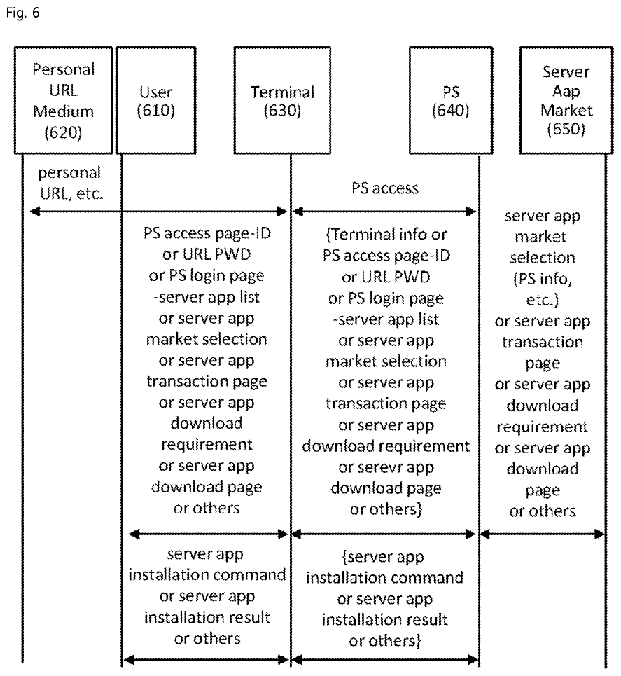

(A server app installation means: see FIG. 5 or FIG. 6) A user, a personal URL medium, a terminal, a PS, a server app market, a personal URL, terminal information, a PS access page-ID, a URL password, a PS login page-server app list, server app market selection, a server app transaction page, a server app download requirement, a server app download page, server app installation command, a server app installation result, or other elements works organically, and the elements above support that the PS, which decides a login with a personal URL, a URL password, terminal information, or other information, installs the server app received from a server app market.

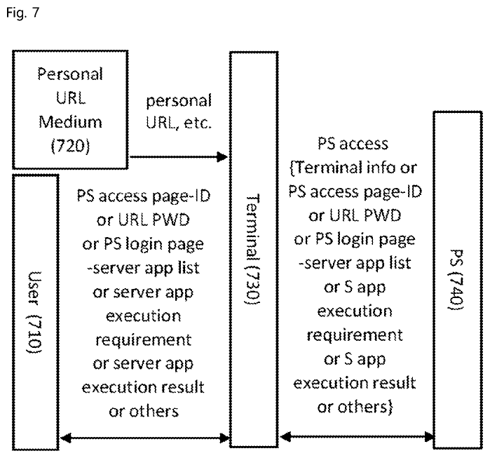

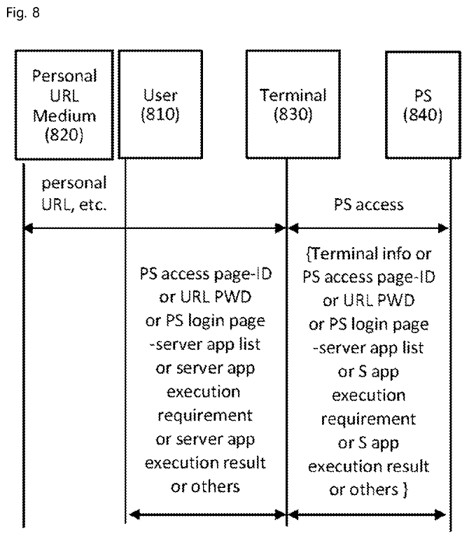

(A server app execution means: see FIG. 7 or FIG. 8) A user, a personal URL medium, a terminal, a PS, a personal URL, terminal information, a PS access page-ID, a URL password, a PS login page-server app list, a server app execution requirement, an S-app execution requirement, an S-app execution result, a server app execution result, or other elements works organically, and the elements above support that a PS, which decides a login with a personal URL, a URL password, terminal information, or other information, runs a server app.

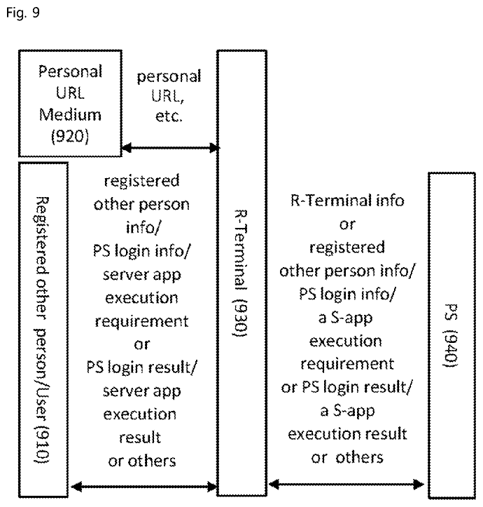

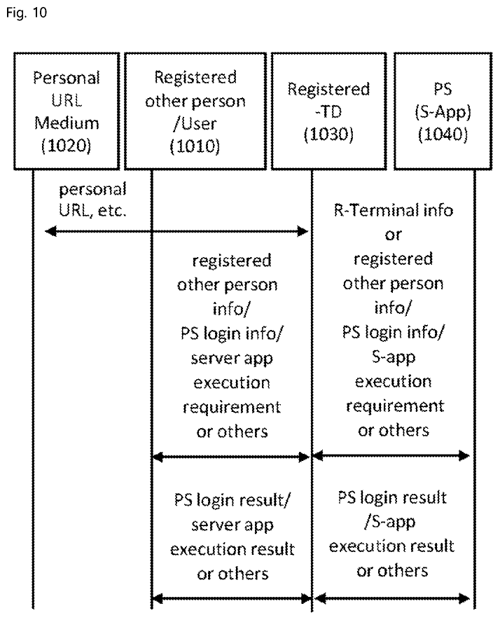

(In face-to-face, a server app execution means capable of running the server app by using the device of other person: see FIG. 9 or FIG. 10) A registered other person/a user, a personal URL medium, a R-terminal, a PS, a personal URL, R-terminal information, registered other person information/PS login information/a server app execution requirement, a PS login result/a S-app execution result, a PS login result/a Server app execution result, or other elements works organically, and the elements above support what running a server app by using the device of other person in face-to-face state.

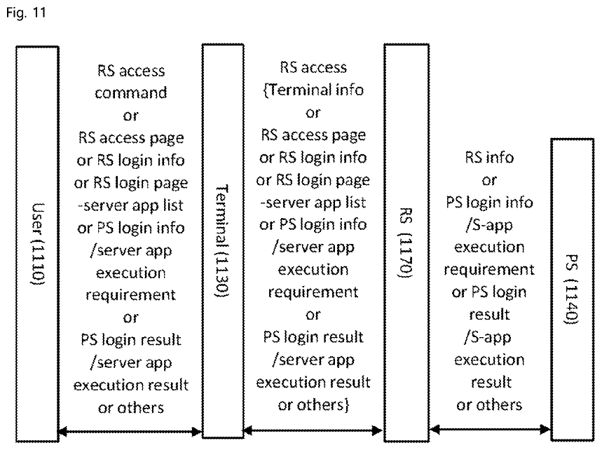

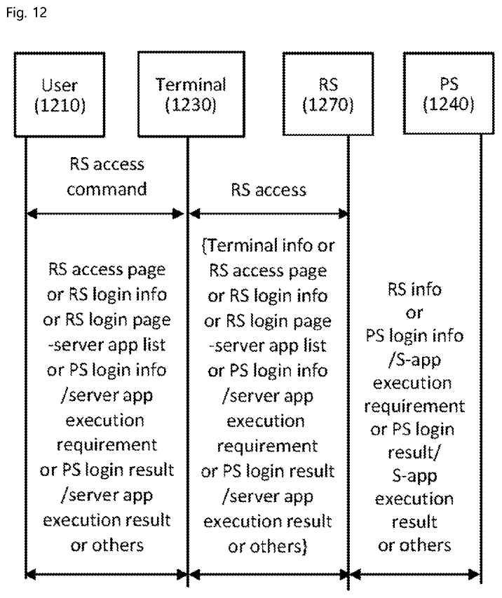

(In non-face-to-face state, a server app execution means capable of running the server app with the device of other person: see FIG. 11 or FIG. 12) A user, a terminal, a RS, a PS, RS access command, terminal information, a RS access page, RS login information, a RS login page-server app list, PS login information/a server app execution requirement, RS information, PS login information/an S-app execution requirement, a PS login result/an S-app execution result, a PS login result/a server app execution result, or other elements works organically, and the elements above support what running a server app by using the device of other person in non-face-to-face state.

a) It can install or run a server app.

b) It can use a server app by checking a user more conveniently and safely. It is convenient because the personal URL of a personal URL medium is delivered to a PS while providing a user ID, and is safer because storage properties and use method of a personal URL, a URL password, and the terminal information are different.

c) It can protect protection information of a server app more safely. Information stored in a terminal can be leaked, but information stored in a server is difficult to leak.

d) It can create the market to trade server apps.

e) It can prevent the damage from contamination of the T-app of a terminal.

f) It can economically prevent contamination or hacking of the T-app of a terminal.

g) It can use a server app at any time because a server app can use the devices of other person. For example, a user can use a server app by using the terminal of a store even if not carry his/her terminal.

h) Other person's devices can directly use the execution result of a user's server app. For example 1: the terminal of a bank employee can check and store the execution result (identification card) of a user's ID card server app. Currently, it is inconvenient and wasteful for a bank employee to copy a user's ID card and manage the copied ID card. For example 2: a company server allows a user's login and can store the user's official document by using an official document server app of the user. Currently, a user receives a paper official document and visits and submits it to a server company, and there is inconvenient and wasteful for a server company to manage the paper official document.

i) It can use more diverse and more advanced services. For example, a virtual terminal server app can support the backup of a terminal, the use of a terminal, or the update of a terminal.

j) It can create added values in the process of starting a server app.

k) It can improve the safety of the entire system (a terminal, a service system, or other devices) using and supporting a service.

### BRIEF DESCRIPTION OF THE DRAWINGS

### <Description of the Existing Drawings>

FIG. 1: The terminal app installation system that the terminal, which decides a login with terminal login information, can install the terminal app received from a terminal app market.

FIG. 2: The terminal app installation method that the terminal, which decides a login with terminal login information, can install the terminal app received from a terminal app market.

FIG. 3: The terminal app execution system that the terminal, which decides a login with terminal login information, runs a terminal app.

FIG. 4: The terminal app execution method that the terminal, which decides a login with terminal login information, runs a terminal app.

<Description of the invention drawings: curly brackets in drawing indicate an access state to help the understanding of the invention and it can indicate an access state even without curly brackets.>

FIG. 5: The server app installation system that the PS, which decides a login with the personal URL of a personal URL medium, a URL password, terminal information, or other information, installs the server app received from a server app market.

FIG. 6: The server app installation method that the PS, which decides a login with the personal URL of a personal URL medium, a URL password, terminal information, or other information, installs the server app received from a server app market.

FIG. 7: The server app execution system that the PS, which decides a login with the personal URL of a personal URL medium, a URL password, terminal information, or other information, can run a server app.

FIG. 8: The server app execution method that the PS, which decides a login with the personal URL of a personal URL medium, a URL password, terminal information, or other information, can run a server app.

FIG. 9: The server app execution system that the PS, which decides a login with the personal URL of a personal URL medium, registered other person's information/PS login information, R-terminal information, or other information, can run a server app. A server app execution system that can run a server app by using other person's device in a face-to-face state.

FIG. 10: The server app execution method that the PS, which decides a login with the personal URL of a personal URL medium, registered other person's information/PS login information, R-terminal information, or other information, can run a server app.

FIG. 11: The server app execution system that the PS, which decides a login with the RS information of the RS logged in by a user, PS login information, or other information, can run a server app. A server app execution system that can run a server app by using other person's device in a non-face-to-face state.

FIG. 12: The server app execution method that the PS, which decides a login with the RS information of the RS logged in by a user, PS login information, or other information, can run a server app.

### DETAILED DESCRIPTION OF EXEMPLARY EMBODIMENTS

Hereinafter, preferred embodiments of the present invention are described in detail with reference to the accompanying drawings. The terms used herein should be interpreted not in typical or dictionary definitions but to comply in concept with the technical matters of the present invention.

The configurations disclosed in the specification and the drawings are mere examples and do not overall represent the technical spirit of the present invention. Therefore, various changes may be made thereto, and equivalents thereof also belong to the scope of the present invention.

The ‘include’ of the specification means what storing, retaining, or relating with results (setting results, operation results, communication results, or other result).

The ‘Include’ of the specification may further include other contents in addition to the contents described in the specification.

URL (Uniform Resource Locator) is to designate the type and location of a file of a server that provide the service of web documents.

RF communication (Radio Frequency Communication) is wireless communication. There is NFC communication, etc.

USB Communication is communication using the USB standard and is wired communication.

Image communication is communication using images. It can access websites by shooting QR codes.

<Definition and explanation for the invention terms: The terms of the invention may have the same expression as the existing terms, but the contents may be different. For example, an attribute of a terminal of the invention may be different from an attribute of an existing terminal.>

(A Server app) a) (Definition) A server app is the app that can be installed in or started in a PS. b) (Configuration) A server app can be composed of an S-app and/or a T-app. A T-app may be omitted. c) (Transaction) A server app can be traded in a server app market. d) (Installation) An S-app can be installed in a PS or a T-app can be installed in an external device of the PS. e) (Execution) An S-app can be started in a PS, the S-app can start a T-app, or the S-app can communicate information with the T-app, server app software, or other device. A T-app can be run in an external device of a PS. f) Protection information of a server app can be stored in a PS. g) A server app can include the function to inspect contaminations of a T-app, the function to check T-app information, the function to use an app key, or other function. h) A server app can prevent the leakage of protection information due to loss or replacement of a terminal. i) (Diversity) A server app can include the various app with the function that cannot be implemented as a terminal app. A server app can also support other person's devices (an R-terminal, a RS, or other device). j) A server app can include the concept of native apps, web apps, or hybrid apps. k) A server app can support various functions. A server app can support the validity period of services by using the creation time of a service (an ID card, government documents, or other service), or prevent the possibility of information leakage by not automatically saving protection information in a terminal when saving a service.

(An S-app) a) An S-app is the server app that can be installed in a PS or started in the PS. b) An S-app can include protection information, an app key, or other information. c) An S-app can use PS's information, self-information, the information received from a SS, or other information. d) An S-app can communicate information with a PS, external devices of a PS, a T-app, server app software, or other device or use it.

(A T-app) a) A T-app is the server app that can be installed in external devices (a terminal, a RS, or other device) of a PS. b) A T-app can include the function controlling external devices, the public information, or other role. c) A T-app can use the information of external devices of a PS, the self-information, the information received from an S-app, or other information. d) A T-app can communicate information with an S-app, PS's external devices, or other device.

(Server app authentication information) a) Server app authentication information is the secret information set in a server app. Server app authentication information can be set in a server app. b) Server app authentication information include the user's remembrance information, 2ndOTP (refer to KR 10-2020-0147182), or other information. c) Server app authentication information can be used in the process of determining a PS login or can be used after a PS login is determined. A user can deliver a server app execution request by selecting a server app of a PS login page-server app list by using server app authentication information in the process of determining a PS login. Also, a user can enter server app authentication information in order to deliver a server app execution requirement by selecting a server app of a PS login-server app list.

(A terminal app vs a server app) a) A terminal app is installed only in a terminal. A server app is installed in a PS and may be further installed in external devices of the PS. b) Protection information of a terminal app is stored in a terminal. Protection information of a server app can be stored in a PS. Protection information of a terminal app can be leaked due to loss of a terminal. Protection information of a server app cannot be leaked due to loss of a terminal. c) A terminal app cannot be started in an external device of a terminal. A server app can be started in a PS. d) A terminal app cannot be run by logging in a terminal's external device. A server app can be run by logging in a PS. e) A terminal app uses a self means to prevent contamination or hacking. A T-app of a server app can link with an S-app to prevent contamination or hacking. f) A terminal app cannot support other person's terminal. A server app can support other person's device (an R-terminal, a RS, or other device). g) A terminal app can be leaked due to loss or replacement of a terminal. An S-app of a server app cannot be leaked due to loss and replacement a terminal. There is the possibility that a T-app be leaked, but it cannot be used illegally in the way that does not store protection information, uses an app key, or other way. h) Since a terminal app stores protection information in a terminal, it is difficult to support high security level information. Since a server app stores protection information in a PS, it can support high security level information. i) Since a terminal app is installed only in a terminal, it is not possible to implement an app that back up or update the terminal. Since an S-app can be installed in a PS and a T-app can be installed in a terminal, it is possible to implement an app that back up or update a terminal. j) Since a terminal app stores protection information in a terminal, the price of the terminal increases. Since a server app can store protection information in a PS, the price of a terminal can be lowered. k) Since a terminal app applies protection means to each a terminal, total price of the protection means is high. Since a server app applies protection means to a PS, total price of the protection means is low.

(A server app identifier) a) A server app identifier is what capable of distinguishing a server app and include an S-app identifier installed in a PS or a T-app identifier installed in external devices of the PS. b) A server app identifier can be implemented as an icon, a server app name, or other identifier (menu's item, etc.). c) A user can run a server app identifier to connect to a server or request execution of a server app.

(A personal URL) a) A personal URL is the URL assigned to an individual (subject), and can include the information that identifies a medium, an individual (subject), a PS, or other information. b) A personal URL can be included in a medium as electronic or image information or other information and it can be encrypted. c) A personal URL can be used as login information by combining with a URL password (secret information), terminal information (terminal's ID), or other information. d) A personal URL can support a server app by connecting a user, a terminal, or other device to a PS. e) A personal URL can provide an ID while supporting a PS access. f) A personal URL can provide a basis for logging in by using a step 1 of verifying an ID and a step 2 of verifying a password. Also, a personal URL can provide a basis to more securely verify a user by specifying and supporting an access path, terminal information, or other characteristics. Since a personal URL is not stored in a terminal and is stored in an offline medium, so it cannot be hacked. Since the personal URL is electronically communicated, so it cannot be stolen while in use. Since the personal URL cannot be leaked simultaneously with a URL password so it can support safety. h) Since a personal URL is used in a different way from a URL password being remembrance information and combined with terminal information or other information, so it can provide a basis for preventing illegal login. i) Since a personal URL supports accessing a server, it may provide a basis for not storing login information, protection information, or other important information in the terminal.

(A URL password) a) A URL password is the password that a user remembers. b) A URL password can be combined with a personal URL (a user ID), terminal information (a terminal's an ID), or other information to be used as login information. c) A URL password can provide a basis for logging in by using a step 1 of checking an ID and a step 2 of checking a password. d) (Advantage) Since it is difficult for a URL password to be leaked at the same time as a personal URL and it must be combined with a personal URL medium, so it is difficult for a URL password to be used illegally.

(A personal URL medium) a) (Definition or overview) A personal URL medium is the medium that includes a personal URL, the information related to a personal URL, or other information. A personal URL medium can be issued or registered individually, include characteristics of a personal URL, or play role as an ID. b) A personal URL medium can provide a basis for a server app by conveniently connecting a user, etc. to a PS. c) (Type) A personal URL medium include a personal URL RF medium supporting RF communication, a personal URL USB medium supporting USB communication, a personal URL image medium supporting image communication (shooting or other image communication), or other mediums. d) A personal URL medium can communicate a personal URL or other information with a terminal or other device.

(Strengths of a personal URL medium) a) (Providing a basis for more conveniently and safely logging in a server) A personal URL medium can provide a basis for logging in by using a step of checking an ID and a step of checking a password. In order to support a login, a personal URL medium can reduce a user's actual behavior or use the information with different attributes in stages. A personal URL medium can support what providing an ID while connecting to a PS even if a terminal's screen security function is operating. b) (Blocking fake website) A personal URL medium can fundamentally block fake websites because it supports what connects to a website by electronically communicating a personal URL. Also, since a personal URL medium cannot be leaked simultaneously with remembrance secret information (URL PWD), the illegal use of a personal URL medium can be fundamentally blocked. Also, illegal access can be economically blocked because a personal URL medium can support specifying an access route, etc. or what linking with terminal information or other information. c) (Blocking of improper use) Since it is not economical to illegally produce and use a personal URL medium, a personal URL medium can fundamentally block illegal use. d) (Convenient and safety) A personal URL medium can be manufactured in a convenient form (bracelets, biometric media, or other form) to minimize loss and increase security.

(A user) a) A user is the subject who can use a server app or a service related to a server app.

(User information) a) User information is the information related to a user. b) User information can include name, personal information (the resident registration number, the SSN or other information), address, contact point, or other information.

(A PS: a personal Server) a) A PS is a personal server and can support an ID of a user. A PS can include an S-app or support a T-app. A PS can include a virtual terminal or other information. A PS can be used as an individual platform to support various services or advertisements. b) (Access) A PS can connect to an external device in response to a personal URL, PS login information, or other information. c) (A PS login) A PS can determine a PS login by using a personal URL, a URL password, terminal information, a personal URL's use way, a access path, a 2ndOTP, or other information (registered other person information, PS login information, RS information, or other information). d) A PS can provide a basis of a server app. e) A PS can communicate information, a web page, or a pop-up window with a terminal, a server app market, a RS, or other device. f) (Installing a server app) A PS can install the server app received from a server app market. A PS can install an S-app of the server app received from a server app market into itself or a T-app of the server app in external devices. g) (Running a server app) A PS can start an S-app and support for an S-app to run a T-app. h) (Supporting protection Information) A PS can store or support protection information of a server app. i) A PS may support self-information, protection information, information received from an external device, or other information in conjunction with a server app. j) A PS can be configured with multiple servers or devices to enhance safety, defend against hacking, or provide various services (a virtual terminal or other service). k) A PS can determine a PS login by using the authentication result received by transmitting a 2ndOTP or PS login information to an OTP-AS (see KR 10-2020-0147182) or other device.

(A virtual terminal) a) A virtual terminal is the device that is created virtually in a server. b) A virtual terminal can be composed of hardware, software, or other elements. A virtual terminal can interwork with a virtual terminal server app or others. c) A virtual terminal can include an S-app or other things. d) A virtual terminal can include the function of a terminal or other functions.

(A PS login vs a terminal login) a) A PS login is what logging into a PS, and a terminal login is what logging into a terminal. The invention can use a terminal by logging into a PS. b) The PS login can be determined with a step 1 of checking an ID and a step 2 of checking a password. The terminal login is determined with only one password. c) (Safety of a PS login) A PS login is very safe because it is determined by checking a plurality of pieces of information (a personal URL, a URL password, terminal information, an access route, or other information), which is not stored in a terminal and has different storage properties or use way, step by step. Therefore, a server app is very safety. d) (Instability of a terminal login) A terminal login is insecure because it is determined with a single piece of information stored in a terminal. Therefore, a terminal app is instability.

(A server app market) a) A server app market is the server or the system that can support the transaction of a server app. A server app market can also support other transactions. b) A server app market can include server apps or other things.

c) A server app market can communicate a server app, a web page, information, a message, or a pop-up window with a PS or other devices.

(A market server app) a) A market server app is the server app that can support a server app market. A market server app can include a market server app identifier. b) A market server app can start in a PS and support what a PS connects to a server app market.

(An app key) a) An app key is the key that can run an app (a T-app or other app). b) An app key can prevent an app from being corrupted or hacked. c) An S-app can run a T-app by using an app key.

(A terminal) a) (Definition or overview) A terminal is the terminal device used directly by a user or a registered other person. A terminal can include a T-app. A terminal includes a user's terminal or other person's terminal, and other person's terminal includes a non-registered other person's terminal or a registered other person's terminal (R-terminal). b) (Type or configuration) A terminal can include a smart phone, a PC, a bank terminal, or other device, and be composed of a plurality of devices. c) (Access) A terminal can connect to a PS, a RS, or other device in response to a personal URL, PS login information, or other information. d) (Communication) A terminal can communicate a personal URL, terminal information, a web page, or a pop-up window with a user, a registered other person, a personal URL medium, a PS, a RS, or other devices. e) (Registration) A terminal can be registered in a PS. For example, a bank terminal or a government office terminal can be registered in a PS and become an R-terminal.

(An R-terminal: a registered terminal) a) (Definition or overview) An R-terminal is the terminal of other person registered in a PS. An R-terminal can include server app software or other elements. b) An R-terminal can receive a personal URL of a personal URL medium and include it into PS login information, or connect to the PS corresponding to the PS login information.

(Terminal information, R-terminal information) a) Terminal information is the information related to a terminal (including a R-terminal) and includes an IP, an OS serial number, an International Mobile Equipment Identification (IMEI), or other information. Terminal information may be registered in a PS. b) Terminal information can be transmitted to a PS, a RS, or other devices. Terminal information can be used to check a terminal's an ID, a user, or a registered other person.

(An RS: A registered server) a) (Definition or overview) A RS is the server registered in a PS. A RS can support a server app in non-face-to-face state. b) A RS can include server app software or other elements. c) A RS can connect to a terminal, a PS, or other devices. d) A RS can determine a RS login by using terminal information, RS login information, or other information. e) A RS can communicate information, a web page, or a pop-up window with a terminal, a PS, or other devices. f) A RS can run a T-app or other functions.

(Server app software) a) Server app software is the software capable of installing in an external device of a PS and supporting a server app. b) Server app software can include a server app list or other functions. c) Server app software can support the function of connecting a PS to an external device of a PS by using PS login information, the function of running an S-app, or other functions. Server app software can include a personal URL into PS login information. d) Server app software can interwork with an S-app, a PS's external device, or other devices. e) A registered other person or a user can request the execution of an S-app by using a server app list of server app software.

(A SS: a service system, a service server) a) A SS is the server that cannot install a server app and can transmit information to a server app. For example, The SS corresponding to an ID card server app cannot install an ID card server app and can support an ID card service by delivering ID information to an ID card S-app. b) A SS can support a server app by interworking with a PS, a terminal, or other devices.

(A PS page) a) A PS page is the web page that a PS can support and it includes a PS access page or a PS login page. b) A PS page can include a server app list, a menu, search function, a pop-up window, information, or an advertisement. c) A user, a terminal, a PS, or other devices can communicate a PS page.

(A PS access page) a) The PS access page is the PS page before a PS login is decided and includes a PS access page-ID and other pages.

(A PS access page-ID) a) A PS access page-ID is the PS access page that can include the result of identifying an ID with a personal URL, terminal information, or other information. A PS access page-ID can include a window inputting a password or other information.

(A PS login page) a) A PS login page is the PS page after a PS login is decided. A PS login page includes a PS login page-server app list or other pages.

(A PS login page-server app list) a) A PS login page-server app list is the PS login page that can include a server app list or other information. A PS login page-server app list can deliver a server app market selection, a server app execution requirement, or other operations.

(A server app list) a) A server app list is the list of server apps. A server app list can include the list of a server app identifier, the list of server app names, or other lists. b) The server app list includes an S-app list, a T-app list, and other lists.

c) The server app list can be provided in the form of a menu. d) A PS, an external device of a PS, or other devices can support a server app list and a registered other person or a user can deliver a PS access requirement, a server app execution requirement, or information by selecting a server app of the server app list.

(A server app market selection) a) A server app market selection is what requesting thing connecting to a server app market. b) A server app market selection can support what connecting to a server app market and include PS information or other information. c) A user, a terminal, a PS, a server app market, or other devices can communicate a server app market selection. d) A user can use a server app market selection with a way selecting a market server app identifier of a PS login page-server app list or other ways.

(A server app transaction page) a) A server app transaction page is the web page that can support the transaction of a server app. A server app transaction page can also support other transaction. b) A server app transaction page can include a server app introduction window (what introducing a server app), a server app search window (what supporting a server app search), a server app download requirement window (what requesting a server app download), or information. c) A server app market, a PS, a terminal, a user, or other devices can communicate a server app transaction page.

(A server app download requirement) a) A server app download requirement is what requesting the download of a server app. b) A user, a terminal, a PS, a server app market, or other devices can communicate a server app download requirement.

(A server app download page) a) A server app download page is the web page that can support the download of a server app. b) A server app download page can include the download of a server app, the progress bar of a download, the result of a download, a server app installation command window (what commanding the installation of a server app), or other information. c) A server app market, a PS, a terminal, a user, or other devices can communicate a server app download page.

(A server app installation command) a) A server app installation command is the command to install a server app. b) A user, a terminal, a PS, or other devices can communicate a server app installation command.

(A server app installation) a) A server app installation is what installing a server app. b) A PS can install an S-app to itself or a T-app in an external device of the PS in response to a server app installation command.

(A server app installation result) a) A server app installation result is the result of installing a server app or responding to a server app installation command. b) A server app installation result can include a server app identifier, a message, a pop-up window, or other information. c) A PS, a PS's external device, a user, or other devices can communicate the server app installation result.

(A server app execution requirement, an S-app execution requirement) a) A server app execution requirement is what requesting the execution of a server app and an S-app execution requirement is what requesting the execution of an S-app. b) A server app execution requirement or an S-app execution requirement can include server app authentication information or other information. c) A user or a registered other person can deliver a server app execution requirement with a way selecting a server app identifier or other way and a terminal, a RS, or other devices can deliver a S-app execution requirement to a PS in response to the server app execution requirement.

(An S-app execution) a) An S-app execution is what running an S-app in a PS. An S-app can be run in a PS in response to an S-app execution requirement. b) An S-app execution can include that an S-app checks and uses server app authentication information, PS information, self-information, the information received from a SS, or other information. c) An S-App execution can include the operations that an S-App communicates information with a PS, an external device of a PS, a T-App, server app software, or other devices, checks information, or does other functions.

(A T-app execution) a) A T-app execution is what running a T-app. A T-app can be run by an S-app or other elements. b) A T-app execution can include the operations that a T-app uses the information of an external device of a PS, self information, the information of an S-app, or other information, controls an external device of a PS, or does other functions. c) A T-app execution can include the operations that a T-app communicates information with an S-app, an external device of a PS, or other devices or does other functions.

(A server app execution) a) A server app execution is what running a server app. A server app execution can include an S-app execution or a T-app execution. A PS can support an S-app execution and an S-app can run a T-app.

(An S-app execution result, a server app execution result) a) An S-app execution result is the result of running an S-app or responding to an S-app execution requirement. A server app execution result is the result of running a server app or responding to a server app execution requirement. b) An S-app execution result can include the result (information or a service) of running an S-app. A server app execution result can include an S-app execution result, a T-app execution result (information or other), the result of running server app software, or other result. c) An S-app can deliver an S-app execution result to an external device of a PS and an external device of a PS can transmit a server app execution result to a terminal, a user, a registered other person, or other devices in response to an S-app execution result.

(A registered other person/a user) a) A registered other person/a user is a registered other person or a user. A registered other person is other person registered in a PS. Other person (a public official, a bank employee, or other employee) whose identity is guaranteed or trusted can register in a PS and become a registered person. b) A registered other person and a user can use a terminal, etc. to run a server app.

(Registered other person information) a) Registered other person information is the information of a registered other person and includes the remembrance information of registered other person, identification information (information of an ID card), or other information. b) For example, a bank employee can tag an ID card to an R-terminal and deliver registered other person information (ID information) to an R-terminal and the R-terminal can confirm the bank employee by delivering the ID information to a PS.

(PS login information, a PS login result) a) PS login information is the information used by a user to log in to a PS by using other person's device (an R-terminal, a RS, or other device). b) PS login information can include a personal URL, an OTP/ID (see KR 10-2020-0147182), or other information. An R-terminal or server app software can include a personal URL received from a personal URL medium in PS login information. Server app software can connect an external device of a PS to the PS of an OTP system corresponding to an OTP/ID. c) A PS login result is the result that a PS determines a PS login with PS login information, terminal information, registered other person information, RS information, or other information in response to the PS login information.

(Registered other person information/PS login information/a server app execution requirement) a) Registered other person information/PS login information/a server app execution requirement is registered other person information, PS login information, or a server app execution requirement. An R-terminal can deliver R-terminal information, registered other person information/PS login information/an S-app execution requirement, or other information to a PS in response to the registered other person information/the PS login information/a server app execution requirement. b) A registered other person, a user, an R-terminal, or other device can communicate registered other person information/PS login information/a server app execution requirement.

(Registered other person information/PS login information/an S-app execution requirement) a) Registered other person information/PS login information/an S-app execution requirement is registered other person information, PS login information, or an S-app execution requirement. b) An R-terminal, a PS, or other device can communicate registered other person information/PS login information/an S-app execution requirement.

(A PS login result/an S-app execution result) a) A PS login result/an S-app execution result is a PS login result or an S-app execution result.

(A PS login result/a server app execution result) a) A PS login result/a server app execution result is a PS login result or a server app execution result.

(A PS access) a) A PS access is what connecting to a PS.

(PS information) a) PS information is the information related a PS and includes a URL of a PS, an IP, or other information. b) PS information can be used as the information to identify a PS's ID or a user, or used as other roles.

(A RS access command) a) A RS access command is the command to connect to a RS. A terminal or other device can connect to a RS in response to a RS access command of a user.

(A RS access) a) A RS access is what connecting to a RS.

(A RS page) a) A RS page is the web page supported by a RS and includes an RS access page or an RS login page. b) A user, a terminal, a RS, or other device can communicate a RS page.

(A RS access page) a) A RS access page is the RS page before a RS login is determined. A RS access page can include the window inputting RS login information or other information.

(RS login information) a) RS login information is the information capable of supporting a RS login. b) RS login information can include a user's remembrance information (an ID or secret information), OTP login information (see KR 10-2020-0147182), or other information.

(A RS login) a) A RS login is what logging in to a RS.

(A RS login page) a) A RS login page is the RS page after a RS login is determined. b) A RS login page includes a RS login page-server app list or other pages.

(A RS login page-server app list) a) A RS login page-server app list is the RS login page that can include a list of server apps or other information. A RS login page-server app list can deliver PS login information/a server app execution requirement or other information.

(PS login information/a server app execution requirement) a) PS login information/a server app execution requirement is PS login information or a server app execution requirement. b) A user, a terminal, a RS, or other device can communicate PS login information/a server app execution requirement. c) A RS can transmit PS login information/an S-app execution requirement to a PS in response to PS login information/a server app execution requirement.

(RS information) a) RS information is the information related to a RS and includes a RS's IP, an OS serial number, or other information. b) RS information can be used to check a RS's ID or a RS.

(PS login information/an S-app execution requirement) a) PS login information/an S-app execution requirement is PS login information or an S-app execution requirement.

(A PS login result/an S-app execution result) a) A PS login result/an S-app execution result is a PS login result or an S-app execution result.

(A PS login result/a server app execution result) a) A PS login result/a server app execution result is a PS login result or a server app execution result.

(Example 1 of a server app: A payment server app that can support PS information or S-app information.) a) A payment S-app delivers protection information (card information, account information, or other information) to a payment T-app (a frame for protection information) and the payment T-app can display the protection information in conjunction with a terminal.

(Example 2 of a server app: An ID information server app that can support PS's information or S-app's information.) a) An ID information S-app transmits ID information to an ID information T-app (a frame for ID information) and the ID information T-app can display the ID information in conjunction with a terminal. A user can register ID information (a name, a resident number, an address, a phone number, a photo, a company, an e-mail address, business card information, or other information) in a PS and use the ID information through the ID information server app. A user can use ID information by using a personal URL medium without holding an ID card. An ID information server app is different from an ID card server app. An ID information server app is not guaranteed by a national institution, and a private company provides ID information through a reliable process. An ID card server app can provide an ID card guaranteed by national institution.

(Example 3 of a server app: An ID card server app that can support services by using information received from a SS.) a) An ID card S-app delivers ID information received from a SS (ID card service system) to an ID card T-app (a frame for an ID card) and the ID card T-app can display an ID card in conjunction with a terminal. b) Type of ID card server app includes an electronic resident registration card server app, an electronic SSN card server app, an electronic passport server app, or other ID card server app.

(Example 4 of a server app: A terminal login server app that can support a terminal login.) a) (Definition) A terminal login server app is the server app that can support a terminal login. b) A terminal login S-app transmits a terminal login command to a terminal login T-app (a module controlling a terminal login) of a terminal and the terminal login T-app can support the terminal login in conjunction with the terminal (releasing the screen security). c) A terminal login server app is safe because it logins into a PS by using a personal URL, a URL password, terminal information, or other information to release a screen security of a terminal and even if a user forgets remembrance information (a URL password), there is no case that a screen security cannot be released because it is possible to reset. The current screen security release is unstable because it uses single secret information stored in a terminal and it cannot be released if a user forgets the single secret information.

(Example 5 of a server app: A virtual terminal server app that can provide a service in conjunction with a terminal and a virtual terminal.) a) (Definition) A virtual terminal server app is the server app that can support a terminal backup, a terminal update, or other operation in conjunction with a terminal or a virtual terminal. b) A virtual terminal S-app can transmit a user's terminal backup command to a virtual terminal T-app in order to back up terminal information to a virtual terminal. Also, a virtual terminal S-app can transmit information of a virtual terminal to a virtual terminal T-app of a terminal in order to update the terminal in response to a user's terminal update command.

<1. A server app installation system. See FIG. 5.> A server app installation system that allows a PS to install a server app received from a server app market, comprising: a personal URL medium that can include a personal URL, etc. or deliver a personal URL to a terminal, etc.; a terminal that can receive a personal URL from a personal URL medium, connect to a PS in response to a personal URL., communicate terminal information, etc. with a PS, communicate a PS access page-ID with a PS or a user, communicate a URL password, etc. with a user, deliver a URL password, etc. to a PS, communicate a PS login page-server app list with a PS or a user, deliver a server app market selection, etc. received from a user to a PS, communicate a server app transaction page with a PS or a user, deliver a server app download requirement, etc. received from a user to a PS, communicate a server app download page with a PS or a user, deliver a server app installation command, etc. received from a user to a PS, or deliver a server app installation result, etc. received from a PS to a user; a PS that can include a server app list, etc., connect to a terminal in response to a personal URL, communicate terminal information, a PS access page-ID or other information with a terminal, receive a URL password, etc. from a terminal, determine a PS login with a personal URL, a URL password, or other information, communicate a PS login page-server app list with a terminal, deliver a server app market selection, etc. received from a terminal to a server app market, communicate a server app transaction page with a server app market or a terminal, deliver a server app download requirement, etc. received from a terminal to a server app market, communicate a server app download page with a server app market or a terminal, receive a server app installation command, etc. from a terminal, install a server app in response to a server app installation command, or deliver a server app installation result, etc. to a terminal; a server app market that can include a server app, etc., receive a server app market selection, etc. from a PS, communicate a server app transaction page with a PS, receive a server app download requirement, etc. from a PS, or communicate a server app download page with a PS; or other components.

<2. A server app installation method. See FIG. 6.> A server app installation method that allows a PS to install a server app received from a server app market, comprising: step a) in which a terminal connects to a PS in response to a personal URL received from a personal URL medium; step b) in which a PS connects to a terminal in response to a personal URL or communicates terminal information, a PS access page-ID, or other information with a terminal; step c) in which a terminal communicates a PS access page-ID with a user or delivers a URL password, etc. received from a user to a PS; step d) in which a PS determines a PS login by using a personal URL, a URL password, or other information or communicates a PS login page-server app list with a terminal; step e) in which a terminal communicates a PS login page-server app list with a user or delivers a server app market selection, etc. received from a user to a PS; step f) in which a PS delivers a server app market selection, etc. to a server app market; step g) in which a server app market communicates a server app transaction page with a PS; step h) in which a PS communicates a server app transaction page with a terminal; step i) in which a terminal communicates a server app transaction page with a user or delivers a server app download requirement, etc. received from a user to a PS; step j) in which a PS delivers a server app download requirement, etc. to a server app market; step k) in which a server app market communicates a server app download page with a PS; step 1) in which a PS communicates a server app download page with a terminal; step m) in which a terminal communicates a server app download page with a user or delivers a server app installation command, etc. received from a user to a PS; step n) in which a PS installs a server app in response to a server app installation command or delivers a server app installation result, etc. to a terminal; step o) in which a terminal delivers a server app installation result, etc. to a user; or other steps.

<3. A server app execution system. See FIG. 7.> A server app execution system that allows a PS to run a server app, comprising: a personal URL medium that can include a personal URL, etc. or deliver a personal URL to a terminal, etc.; a terminal that can include a T-app of a server app, etc., receive a personal URL from a personal URL medium, connect to a PS in response to a personal URL, communicate terminal information, etc. with a PS, communicate a PS access page-ID with a PS or a user, communicate a URL password, etc. with a user, deliver a URL password, etc. to a PS, communicate a PS login page-server app list with a PS or a user, receive a server app execution requirement, etc. from a user, deliver an S-app execution requirement, etc. to a PS, receive an S-app execution result, etc. from a PS, or deliver to a user a server app execution result, etc. capable of including an S-app execution result, a T-app execution result, or other result; a PS that can include an S-app of a server app, etc., connect to a terminal in response to a personal URL, communicate terminal information, a PS access page-ID, or other information with a terminal, receive a URL password, etc. from a terminal, determine a PS login with a personal URL, a URL password, or other information, communicate a PS login page-server app list with a terminal, receive an S-app execution requirement, etc. from a terminal, run an S-app in response to an S-app execution requirement, or deliver an S-app execution result, etc. to a terminal; or other components.

<4. A server app execution method. See FIG. 7.> A server app execution method that allows a PS to run a server app, comprising: step a) in which a terminal connects to a PS in response to a personal URL received from a personal URL medium; step b) in which a PS connects to a terminal in response to a personal URL or communicates terminal information, a PS access page-ID, or other information with a terminal; step c) in which a terminal communicates a PS access page-ID with a user or delivers a URL password, etc. received from a user to a PS; step d) in which a PS determines a PS login with a personal URL, a URL password, or other information or communicates a PS login page-server app list with a terminal; step e) in which a terminal communicates a PS login page-server app list with a user, receives a server app execution requirement, etc. from a user, or delivers an S-app execution requirement, etc. to a PS; step f) in which a PS runs an S-app in response to an S-app execution requirement or delivers an S-app execution result, etc. to a terminal; step g) in which a terminal delivers to a user a server app execution result, etc. capable of including an S-app execution result, a T-app execution result, or other information; or other steps.

<5. A server app execution system in a face-to-face state. See FIG. 9.> A server app execution system that allows a PS to run a server app, comprising: a personal URL medium that can include a personal URL, etc. or deliver a personal URL to a R-terminal, etc.; a R-terminal that can include a T-app of a server app, etc., receive a personal URL from a personal URL medium, receive registered other person information, PS login information, a server app execution requirement, or other information from a registered other person or a user, deliver R-terminal information, registered other person information, PS login information, an S-app execution requirement, or other information to a PS corresponding to a personal URL, receive a PS login result, an S-app execution result, or other information from a PS, or deliver to a registered other person or a user a server app execution result, a PS login result, or other information, in which a server app execution result can include an S-app execution result, a T-app execution result, or other information; a PS that can include an S-app of a server app, etc., receive R-terminal information, registered other person information, PS login information, or an S-app execution requirement from a R-terminal, determine a PS login by using R-terminal information, registered other person information, PS login information, or other information, run an S-app in response to an S-app execution requirement, or deliver to a R-terminal a PS login result, an S-app execution result, or other result; or other components.

<6. A server app execution system in a face-to-face state. See FIG. 9.> A server app execution system that allows a PS to run a server app, comprising: step a) in which a R-terminal receives a personal URL from a personal URL medium, receives the registered other person information, the PS login information, a server app execution requirement, or other information from a registered other person or a user, or delivers the R-terminal information, the registered other person information, the PS login information, an S-app execution requirement, or other information to the PS corresponding to the personal URL; step b) in which the PS determines a PS login by using the R-terminal information, the registered other person information, the PS login information or other information, runs an S-app in response to the S-app execution requirement, or delivers a PS login result, an S-app execution result, or other information to the R-terminal; step c) in which the R-terminal delivers to the registered other person or the user a server app execution result, the PS login result, or other information, in which the server app execution result can include the S-app execution result, a T-app execution result, or other information; or other steps.

<7. A server app execution system in a non-face-to-face state. See FIG. 11.> A server app execution system that allows a PS to run a server app, comprising: a terminal that can connect to a RS in response to a user's RS access command, communicate terminal information, etc. with a RS, communicate a RS access page with a RS or a user, communicate RS login information, etc. with a user, deliver RS login information, etc. to a RS, communicate a RS login page-server app list with a RS or a user, deliver PS login information, a server app execution requirement, or other information received from a user to a RS, or deliver to a user a PS login result, a server app execution result, or other information received from a RS; a RS that can include a server app list, a T-app of a server app, or other information, connect to a terminal, communicate terminal information, a RS access page, or other information with a terminal, receive RS login information, etc. from a terminal, determine RS login by using RS login information, terminal information, or other information, communicate a RS login page-server app list with a terminal, receive PS login information, a server app execution requirement, or other information from a terminal, deliver RS information, PS login information, an S-app execution requirement, or other information to a PS corresponding to PS login information, receives a PS login result, an S-app execution result, or other information from a PS, or deliver to a terminal a server app execution result, a PS login result, or other information, in which a server app execution result can include an S-app execution result, a T-app execution result, or other information; a PS that can include an S-app of a server app, etc., receive RS information, PS login information, an S-app execution requirement, or other information from a RS, determine a PS login by using RS information, PS login information, or other information, run an S-app in response to an S-app execution requirement, or deliver a PS login result, an S-app execution result, or other information to a RS; or other components.

<8. A server app execution method in a non-face-to-face state. See FIG. 12.> A server app execution system that allows a PS to run a server app, comprising: step a) in which a terminal connects to a RS in response to a user's RS access command; step b) in which a RS connects to a terminal or communicates terminal information, a RS access page, or other information with a terminal; step c) in which a terminal communicates a RS access page with a user or delivers RS login information, etc. received from a user to a RS; step d) in which a RS determines RS login with RS login information, terminal information, or other information or communicates a RS login page-server app list with a terminal; step e) in which a terminal communicates a RS login page-server app list with a user or delivers PS login information, a server app execution requirement, or other information received from a user to a RS; step f) in which a RS delivers RS information, PS login information, an S-app execution requirement, or other information to a PS corresponding to PS login information; step g) in which a PS determines a PS login by using RS information, PS login information, or other information, runs an S-app in response to an S-app execution requirement, or delivers a PS login result, an S-app execution result, or other information to a RS; step h) in which a RS delivers to a terminal a server app execution result, a PS login result, or other information, in which a server app execution result can include an S-app execution result, a T-app execution result, or other information; step i) in which a terminal delivers a PS login result, a server app execution result, or other information to a user; or other steps.

(Description of the number of the existing drawing)
110, 210, 310, 410: User
130, 230, 330, 430: Terminal
150, 250: Terminal app market
   (Description of the number of the invention drawing)
510, 610, 710, 810, 1110, 1210: User
910, 1010: a registered other person/a user
520, 620, 720, 820, 920, 1020: personal URL medium
530, 630, 730, 830, 1130, 1230: terminal 930, 1030: R-terminal, Registered terminal
540, 640, 740, 840, 940, 1040, 1140, 1240: PS, personal server
550, 650: Server app market
1170, 1270: RS, Registered Server

1. A server app installation system that a PS capable of determining a PS login by using a personal URL or a URL password or terminal information can install a server app received from a server app market, comprising:
a personal URL medium that can include the personal URL and deliver the personal URL to a terminal;
the terminal that can receive the personal URL from the personal URL medium, connect to the PS in response to the personal URL, communicate the terminal information with the PS, communicate a PS access page-ID with the PS or a user, receive the URL password from the user, deliver the URL password to the PS, communicate a PS login page-server app list with the PS or the user, deliver a server app market selection received from the user to the PS, communicate a server app transaction page with the PS or the user, deliver a server app download requirement received from the user to the PS, communicate a server app download page with the PS or the user, deliver a server app installation command received from the user to the PS, and deliver a server app installation result received from the PS to the user;
the PS that can include a server app list, connect to the terminal in response to the personal URL, communicate the terminal information and the PS access page-ID with the terminal, receive the URL password from the terminal, determine the PS login by using the personal URL or the URL password or the terminal information, communicate the PS login page-server app list with the terminal, deliver the server app market selection received from the terminal to the server app market, communicate the server app transaction page with the server app market or the terminal, deliver the server app download requirement received from the terminal to the server app market, communicate the server app download page with the server app market or the terminal, receive the server app installation command from the terminal, install the server app in response to the server app installation command, and deliver the server app installation result to the terminal; and
the server app market that can include the server app, receive the server app market selection from the PS, communicate the server app transaction page with the PS, receive the server app download requirement from the PS, and communicate the server app download page with the PS.

2. (canceled)

3. A server app execution system that a PS capable of determining a PS login by using a personal URL or a URL password or terminal information can run a server app, comprising:
a personal URL medium that can include the personal URL and deliver the personal URL to a terminal;
the terminal that can include a T-app of the server app, receive the personal URL from the personal URL medium, connect to the PS in response to the personal URL, communicate the terminal information with the PS, communicate a PS access page-ID with the PS or a user, receive the URL password from the user, deliver the URL password to the PS, communicate a PS login page-server app list with the PS or the user, receive a server app execution requirement from the user, deliver an S-app execution requirement to the PS, receive an S-app execution result from the PS, and deliver to the user a server app execution result capable of including the S-app execution result or a T-app execution result; and
the PS that can include an S-app of the server app, connect to the terminal in response to the personal URL, communicate the terminal information and the PS access page-ID with the terminal, receive the URL password from the terminal, determine the PS login by using the personal URL or the URL password or the terminal information, communicate the PS login page-server app list with the terminal, receive the S-app execution requirement from the terminal, run the S-app in response to the S-app execution requirement, and deliver the S-app execution result to the terminal.

4. (canceled)

5. A server app execution system that a PS capable of determining a PS login by using PS login information or R-terminal information or registered other person information can run a server app, comprising:
a personal URL medium that can include a personal URL and deliver the personal URL to a R-terminal;
the R-terminal that can include a T-app of the server app, receive the personal URL from the personal URL medium, receive the PS login information or a server app execution requirement or the registered other person information from a registered other person or a user, deliver the PS login information or an S-app execution requirement or the R-terminal information or the registered other person information to the PS corresponding to the personal URL, receive a PS login result and an S-app execution result from the PS, and deliver the PS login result and a server app execution result capable of including the S-app execution result or a T-app execution result to the registered other person or the user; and
the PS that can include an S-app of the server app, receive the PS login information or the S-app execution requirement or the R-terminal information or the registered other person information from the R-terminal, determine the PS login by using the PS login information or the R-terminal information or the registered other person information, run the S-app in response to the S-app execution requirement, and deliver the PS login result and the S-app execution result to the R-terminal.

6. (canceled)

7. A server app execution system that a PS capable of determining a PS login by using PS login information or RS information can run a server app, comprising:
a terminal that can connect to the RS in response to a RS access command of a user, communicate terminal information with a RS, communicate a RS access page with the RS or the user, receive RS login information from the user, deliver the RS login information to the RS, communicate a RS login page-server app list with the RS or the user, deliver the PS login information and a server app execution requirement received from the user to the RS, and deliver to the user a PS login result and a server app execution result received from the RS;
the RS that can include a server app list and/or a T-app of the server app, connect to the terminal, communicate the terminal information and the RS access page with the terminal, receive the RS login information from the terminal, determine a RS login by using the RS login information and/or the terminal information, communicate the RS login page-server app list with the terminal, receive the PS login information or the server app execution requirement from the terminal, deliver the PS login information, an S-app execution requirement, and the RS information to the PS corresponding to the PS login information, receives the PS login result and an S-app execution result from the PS, and deliver the PS login result and the server app execution result capable of including the S-app execution result or a T-app execution result to the terminal; and
the PS that can include an S-app of the server app, receive the PS login information, the S-app execution requirement, or the RS information from the RS, determine the PS login by using the PS login information or the RS information, run the S-app in response to the S-app execution requirement, and deliver the PS login result and the S-app execution result to the RS.

8. (canceled)
